(19) United States
(12) Patent Application Publication
(10) Pub. No.: US 2004/0072491 A1
(43) Pub. Date: Apr. 15, 2004

(54) Spunlaced loop material for a refastenable fastening device and methods of making same

(76) Inventors: Samuel Mark Gillette, Burlington, NC (US); James William Flippin, Greensboro, NC (US); Walter Gomer Jones, Greensboro, NC (US); Zareh Mikaelian, Greensboro, NC (US); Alfred Frank Baldwin JR., Greensboro, NC (US)

Correspondence Address: MYERS BIGEL SIBLEY & SAJOVEC, PO BOX 37428, RALEIGH, NC, 27627, US

(21) Appl. No.: 10/643,610

(22) Filed: Aug. 19, 2003

Related U.S. Application Data
(63) Continuation-in-part of application No. 10/266,917, filed on Oct. 8, 2002.
(60) Provisional application No. 60/388,397, filed on Jun. 12, 2002.

(51) Int. Cl. B32B 3/02; B32B 33/00; B32B 3/06; D05C 17/00; D03D 27/00

(52) U.S. Cl. 442/408; 442/340; 442/381; 442/409; 442/268; 442/394; 428/92; 428/100

(57) ABSTRACT

A loop component for use in a hook and loop fastening system, and methods of making same are provided, wherein a spunlaced fabric having a plurality of loop structures is formed by entangling a plurality of non-interbonded fibers in a fibrous web of material. The loop structures are configured to engage hooks from a hook component having a hook density between about 30 and 400 hooks per square centimeter, and have a peel strength of between about 50 grams and 2000 grams. The spunlaced fabric may include a backing layer. Between about two percent and about twenty-five percent (2%-25%) of the spunlaced fabric may be bonded to reduce fiber fuzzing and pull out that may occur when hooks are engaged and disengaged from the loop material. The spunlaced fabric may be stretched in a cross web (widthwise) direction between about 5% and about 125% of the original width to produce a fabric with greater void area for better hook engagement.

### RELATED APPLICATION

This application is a continuation-in-part of U.S. application Ser. No. 10/266,917, filed Oct. 8, 2002, which claims the benefit of U.S. Provisional Application No. 60/388,397, filed Jun. 12, 2002, the disclosures of which are incorporated herein by reference in their entireties as if set forth fully herein.

### FIELD OF THE INVENTION

The present invention relates generally to fastening systems and, in particular, to loop material for hook and loop fastening systems.

### BACKGROUND OF THE INVENTION

Hook and loop fastening systems are becoming prevalent in many durable and nondurable applications and are replacing other fastening devices such as tape, buckles, zippers and snaps. In general, hook and loop fastening systems include a male hook member, having a plurality of upstanding hook engaging elements, and a female loop member having a plurality of loops in which the hook members become ensnarled to effect fastening engagement of the two components.

Unfortunately, many of the hook and loop fastening systems available today can be difficult to manufacture or can have other drawbacks which may limit their utility. For example, woven and knit fabrics may require complex equipment and multiple processes in order to construct a loop material. Conventional nonwoven loop systems require inter-fiber bonding to reduce fiber spreading and accommodate hooks from a hook component. (e.g., see U.S. Pat. No. 5,326,612 to Goulait). Moreover, conventional loop member material may not be soft enough for personal hygiene applications, such as disposable diapers, surgical gowns, sanitary napkins, etc. Another drawback of conventional hook and loop fastening systems is that fiber fuzzing and pull out may occur as a result of repetitive engagement and disengagement of hooks from a male component.

### SUMMARY OF THE INVENTION

Applicants have discovered that spunlaced fabric having non-interbonded fibers (i.e., fibers not bonded to other fibers) can be produced that will engage hooks of hook and loop fastening systems with acceptable peel strength, as described in ASTM D-5170-98. A spunlaced fabric is a fabric which has been formed by impinging a web (which can include preformed fabrics, spunmelt webs, air laid webs and carded webs) with jets of high pressure water. Spunlaced fabrics have conventionally not been expected to offer any utility in the design of a loop material for a hook and loop fastening system. This is because the consolidation of fibers via water jets has been considered unsuitable for forming loops for use in hook and loop fastening systems. However, Applicants have unexpectedly discovered that a loop structure conducive to penetration and engagement by hook members can be created from spunlaced fabrics.

According to embodiments of the present invention, a method of forming a loop component for use in a hook and loop fastening system includes forming a spunlaced fabric having loop structures with no inter-fiber bonds, and bonding the spunlaced fabric to a backing layer to produce a loop component. Loop components according to embodiments of the present invention can have loop structures configured to engage hooks from a hook component having a hook density between about 30 and 400 hooks per square centimeter. Loop structures according to embodiments of the present invention can have a peel strength of between about 50 grams and 2000 grams, and can have a shear strength of between about 1,000 and 15,000 grams.

According to other embodiments of the present invention, a method of forming a loop component for use in a hook and loop fastening system includes forming a spunlaced fabric having loop structures with no inter-fiber bonds and bonding (e.g., thermally, ultrasonically, etc.) between about two percent and about twenty-five percent (2%-25%) of the spunlaced fabric to reduce fiber “fuzzing” and “pull out” that may occur when hooks are engaged and disengaged from the loop material. Bonding the spunlaced fabric may include autogenously bonding the spunlaced fabric in multiple spaced apart patterns or in a continuous bond pattern. Bonding may be performed directly to the spunlaced fabric itself. Alternatively, the spunlaced fabric may be bonded to a decorative film or fabric.

According to other embodiments of the present invention, a method of forming a loop component for use in a hook and loop fastening system includes forming a spunlaced fabric having loop structures with no inter-fiber bonds and stretching the spunlaced fabric in a cross web (widthwise) direction between about 5% and about 125% of the original width of the spunlaced fabric. Stretching in the cross web direction may be performed in a variety of ways including, but not limited to, stretching via ring rolls or interdigitating rolls, bow rolls, tentering, etc. Stretching spunlaced fabric in the cross web direction tends to produce a fabric with greater void area for better hook engagement. In addition, stretching spunlaced fabric in the cross web direction can produce a fabric that can be lower in basis weight than can be produced on conventional spunlacing equipment.

Embodiments of the present invention can provide aesthetically pleasing hook and loop fastening systems. Spunlaced loop member materials according to embodiments of the present invention are superior to conventional loop member materials because of the visual consistency and soft hand obtained. Moreover, loop members according to embodiments of the present invention have utility in a broad range of applications, particularly personal hygiene applications, such as disposable diapers, surgical gowns, sanitary napkins, etc.

### BRIEF DESCRIPTION OF THE DRAWINGS

The accompanying drawings, which form a part of the specification, illustrate embodiments of the present invention. The drawings and description together serve to fully explain the invention.

FIG. 1 is a flow diagram that illustrates methods of forming a loop component for use in a hook and loop fastening system, according to embodiments of the present invention.

FIG. 2 is a flow diagram that illustrates operations for forming a spunlaced fabric having loop structures with no inter-fiber bonds, according to embodiments of the present invention.

FIGS. 3A-3V illustrate examples of bonding patterns that may be utilized according to embodiments of the present invention.

FIG. 3W illustrates an exemplary print pattern that may be utilized according to embodiments of the present invention.

FIGS. 4-7 are flow diagrams that illustrate operations for forming a spunlaced fabric having loop structures with no inter-fiber bonds, according to other embodiments of the present invention.

### DETAILED DESCRIPTION OF THE INVENTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

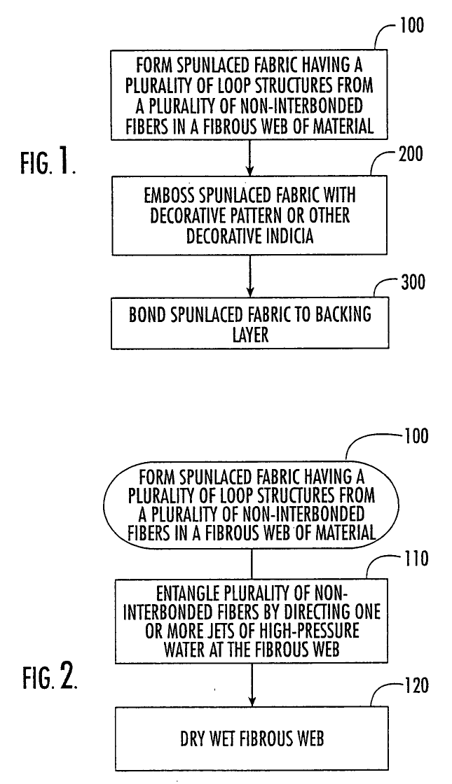

Referring now to FIG. 1, a method of forming a loop component for use in a hook and loop fastening system, according to embodiments of the present invention, includes forming a spunlaced fabric having a plurality of loop structures from a plurality of non-interbonded fibers (i.e., fibers not bonded to other fibers) in a fibrous web of material (Block 100), optionally embossing the spunlaced fabric with a decorative pattern or other decorative indicia (Block 200), and optionally bonding the spunlaced fabric to a backing layer (Block 300).

A loop component according to embodiments of the present invention can have loop structures configured to engage hooks from a hook component having a hook density between about 30 and 400 hooks per square centimeter. The loop structures can have a peel strength of between about 50 grams and 2000 grams (preferably 300-700 grams) using ASTM D5170-98, and can have peak shears of between about 1,000 and 15,000 grams (preferably 1,800-9,000 grams) using ASTM D5169-91.

FIG. 2 illustrates operations for forming a spunlaced fabric having loop structures with no inter-fiber bonds. Non-interbonded fibers in a fibrous web of material are entangled to form a plurality of loop structures by directing one or more jets of high-pressure water at the fibrous web of material (Block 110). The fibrous web may contain randomly oriented fibers or substantially aligned fibers. Exemplary fibers include, but are not limited to, polypropylene, polyethylene, polyethylene terephthalate, polyester, acetate, nylon, viscose and acrylic, and blends thereof. Bicomponent fibers of such polymers may also be used. Exemplary fibrous webs include preformed fabrics, spunmelt webs, air laid webs, carded webs, etc. The spunlaced fabric may be homogenous according to embodiments of the present invention.

Fibers within spunlaced fabrics, according to embodiments of the present invention, preferably have a denier of between about 0.5 and 19, and a density of between about 0.1 and 1.2 grams per cubic centimeter. However, embodiments of the present invention are not limited to fibers having this denier range or this density range. A spunlaced fabric according to embodiments of the present invention preferably has a thickness of between about 10 and 95 mils. However, embodiments of the present invention are not limited to spunlaced fabrics having this thickness range.

Well distributed and entangled fibers impart strength, consistency (visual coverage, uniform thickness and basis weight uniformity), smoothness and softness to spunlaced fabrics. The degree of fiber entanglement provided by water jet impingement can control the degree to which the fabric fuzzes after repeated peels from a hook member.

According to embodiments of the present invention, a batt of fibrous material may be formed above and below a spunbonded fabric or net. Fibers from the three layers may then be entangled via water jets (hydroentangling) to produce a spunlaced fabric.

The wet fibrous web of material may then be dried, for example using a vacuum box and a dryer (Block 120). If a finish and/or color is to be added to the spunlace fabric, a padder may be utilized, as is known to those skilled in the art. Another dryer immediately following the padder to dry the fibrous web may also be utilized. Additionally, the web can be apertured during the process.

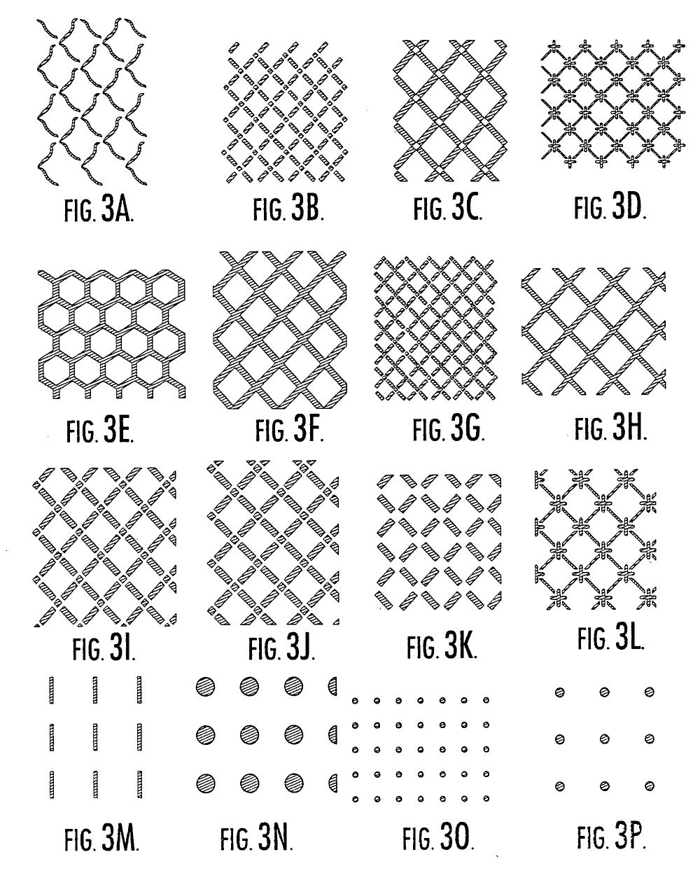

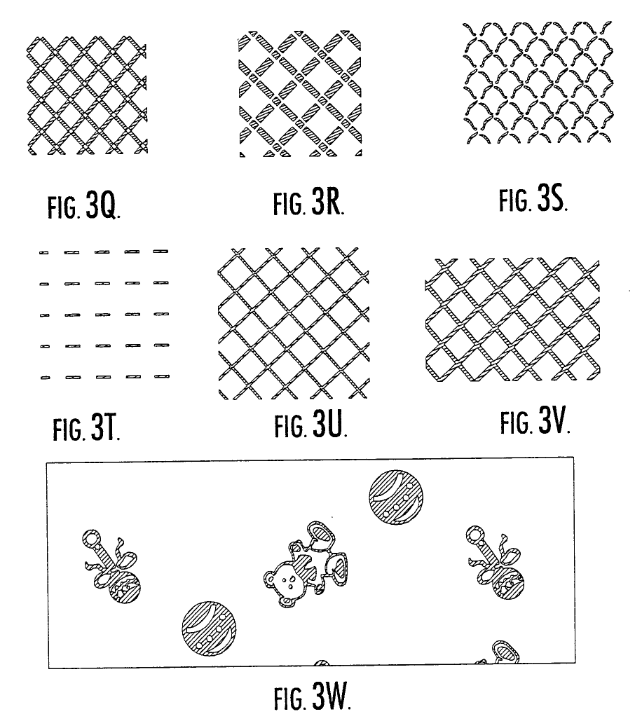

The optional step of embossing a spunlaced fabric with a decorative pattern or other decorative indicia (Block 200) may provide additional dimensional stability to the spunlaced fabric. FIG. 3W illustrates an exemplary decorative pattern that may be embossed and/or printed. Various decorative patterns may be utilized, however, without limitation. Embossing may be performed in various ways including, but not limited to, via thermal energy, ultrasonic energy, and/or heat and pressure. Preferably, the elements of the design have a pattern that has dimensions between about 0.02 mm to 4.0 mm, and the repeat unit is about 0.2 cm to 12.0 cm.

An optional backing layer may provide additional dimensional stability, and may increase the durability of the structure to hook release forces and repeat engagements. A backing layer can also provide aesthetics by having various types of decorative indicia and/or colors. A backing layer may also help reduce “fuzzing” of a spunlaced fabric after repeated “peels” from a hook member, and may help reduce fiber “pull-out” from the spunlaced fabric.

Bonding the spunlaced fabric to a backing layer to produce a loop component (Block 300) may include bonding the spunlaced fabric to various types of materials. A composite backing layer and spunlaced fabric according to embodiments of the present invention may have a MD (machine direction) grab tensile strength of between about 10 pounds and 40 pounds. Moreover, a composite backing layer and spunlaced fabric according to embodiments of the present invention may have a Frazier air permeability of less than about 25 cubic feet per minute.

Bonding may be performed in one or more patterns. Bonding may be done using thermal or ultrasonic processes, autogenously, or may be attached using an adhesive, or using combinations of such techniques. The term “autogenously” means that the spunlaced fabric is secured to a backing layer without the aid of a third material. For example, spunlaced fabric can be fused or melted into a backing layer, and can be done so in a pattern. The bond area may be between about 2.5% and 25% of the surface area of the backing layer. FIGS. 3A-3V illustrate various bond patterns that may be utilized in accordance with embodiments of the present invention. However, it is understood that other bond patterns may also be utilized.

A backing layer may be a film, nonwoven fabric, lightweight woven fabric, or knit scrim. If the backing layer is a film it may be produced from a polymer such as polypropylene, polyester, polyolefin, polyvinyl alcohol, block copolymer, elastomeric polymer, copolyester, copolyether ester, urethane, styrene block copolymer, elastic foam, polyvinyl chloride, copolyether amide such as Pebax®, or combinations thereof. The most preferred polymer is a low-density polyethylene. Optionally, the film can be impervious to water. Film thickness may range from about 0.00025 inches to about 0.010 inches, with the most preferred range being from about 0.0006 inches to about 0.002 inches. The density of a backing layer film may be between about 0.65 grams per cubic centimeter and about 1.4 grams per cubic centimeter. Corona treatment of a backing layer film is optional for embodiments of the present invention.

For fabric backing layers, all of the nonwoven technologies such as spunbonded, thermal bonded, resin bonded, needle punched, stitch bonded, flash spun, spunlaced, wet-laid, thru-air bonded, and others known to those skilled in the art, would be appropriate. Paper, woven fabric, and knitted fabric could also be used.

Optionally, a fabric backing layer may be printed with a pattern, characters, and or other decorative indicia. A printed pattern and/or indicia may be used in addition to a pattern used in bonding.

Backing layers according to embodiments of the present invention preferably have a thickness of between about 0.4 and 40 mils, and a density of between about 0.65 and 1.4 grams per cubic centimeter. However, embodiments of the present invention are not limited to backing layers having this thickness range or this density range.

Hook and loop fastening systems according to embodiments of the present invention can be used as material for disposable diapers and other garments, and can be attached to the waist portion of disposable diapers and other garments utilizing techniques known to those skilled in the art. For example, embodiments of the present invention can be used as the waist band of a disposable diaper or other garment.

According to embodiments of the present invention, a hook and loop fastening system is provided that utilizes a female loop component as described above in conjunction with a male hook component of virtually any type. Preferably, a loop component has loop structures configured to engage hooks from a hook component having a hook density between about 30 and 400 hooks per square centimeter. Preferably, the loop structures have a peel strength of between about 50 grams and 2000 grams using ASTM D5170-98, and have peak shears of between about 1,000 and 15,000 grams using ASTM D5169-91. Exemplary hook components are available, for example, from Bender. Hook components may be formed from fibers of a wide range of materials. Suitable materials include, but are not limited to nylon, polyester, polypropylene, or any combination of these or other materials.

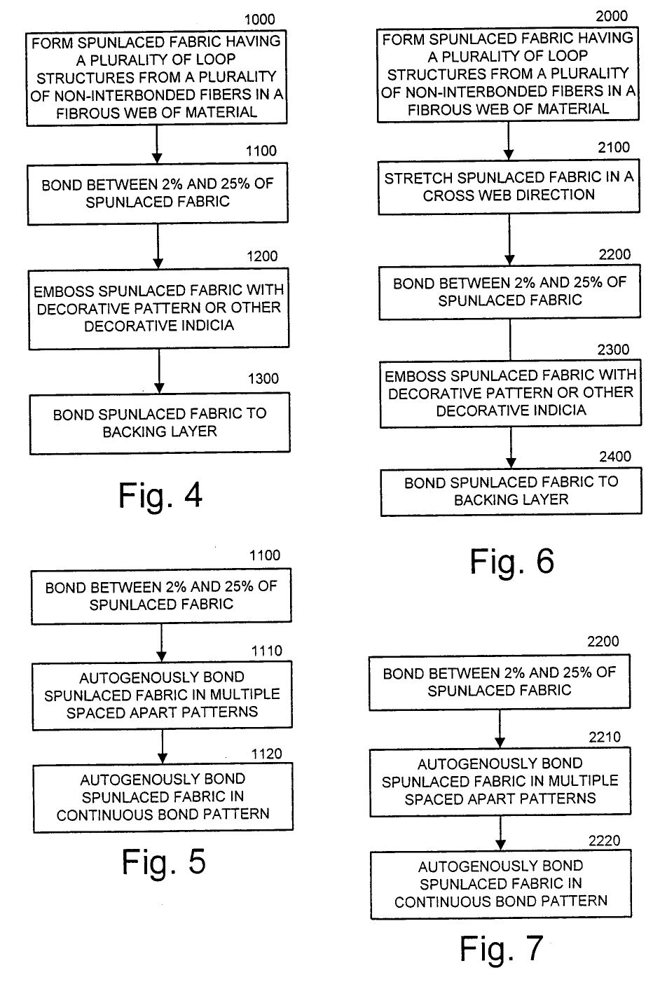

Referring now to FIGS. 4-5, a method of forming a loop component for use in a hook and loop fastening system, according to other embodiments of the present invention, includes forming a spunlaced fabric having a plurality of loop structures from a plurality of non-interbonded fibers (i.e., fibers not bonded to other fibers) in a fibrous web of material (Block 1000), bonding one or more portions of the spunlaced fabric (Block 1100), optionally embossing the spunlaced fabric with a decorative pattern or other decorative indicia (Block 1200), and optionally bonding the spunlaced fabric to a backing layer (Block 1300).

Bonding the spunlaced fabric (Block 1100) may include autogenously bonding the spunlaced fabric in multiple spaced apart patterns (Block 1110) or autogenously bonding the spunlaced fabric in a continuous bond pattern (Block 1120) (FIG. 5). Various bonding patterns may be used including, but not limited to, lines, diamonds, squares, etc. Bonding may be performed in a variety of ways known to those skilled in the art including, but not limited to, thermal bonding and ultrasonic bonding. Bonding may be performed directly to the spunlace fabric itself. Alternatively, the spunlaced fabric may be bonded to a decorative film or fabric. According to embodiments of the present invention, between about two percent and about twenty-five percent (2%-25%) of the surface area of a spunlaced fabric is bonded.

Bonding the spunlaced fabric (Block 1100) is not necessary for the attachment functionality of the loop structure of the spunlaced fabric. Bonding is performed to reduce the amount of fiber “fuzzing” and fiber “pull out” that may occur when hooks are engaged and disengaged from the loop material. Fiber fuzzing and fiber pull out may occur when male hook components are engaged with and disengaged from the loop structure of the spunlaced fabric. Applicants have unexpectedly discovered that bonding between about 2.5% and about 25% of the surface area of a spunlaced fabric reduces the tendency of the fibers to fuzz and/or pull out. The term fiber “fuzzing” refers to fiber fraying and other types of fiber wear caused by repetitive engagement and disengagement of hooks. The term fiber “pull out” refers to separation of fibers from the spunlaced fabric.

Reduced fiber fuzzing and pull out provided by embodiments of the present invention can improve the aesthetics of a female component of a hook and loop fastener and can provide dimensional stability for the female component. Moreover, embodiments of the present invention can provide adequate peel and shear strength in a limited use hook and loop fastening system, such as for diapers, adult incontinence briefs, etc.

Spunlaced fabrics according to embodiments of the present invention may be formed from various fibers including, but not limited to, polypropylene, polyester, nylon, polyethylene or a blend of these fibers.

The basis weight of a spunlaced fabric according to embodiments of the present invention may be between about 15 and about 75 grams per meter (ASTM D5261). The average peel strength of a spunlaced fabric according to embodiments of the present invention may be between about 50 grams and about 750 grams force. The average maximum load (highest peak) peel strength of a spunlaced fabric according to embodiments of the present invention may be between about 200 and 7,000 grams force. The average maximum load shear strength of a spunlaced fabric according to embodiments of the present invention may be between about 700 and 10,000 grams force (ASTM D5170-98 and ASTM D5169-91). The air permeability of a spunlaced fabric according to embodiments of the present invention may be between about 250 and 800 cubic feet per minute (ASTM D 737). The caliper or thickness of a spunlaced fabric according to embodiments of the present invention may be between about 0.010 and 0.045 inches (ASTM D-5199).

The “landing zone” (i.e., the portion of a spunlaced fabric that receives hooks from a male component of a hook and loop fastener) material of spunlaced fabric according to embodiments of the present invention can be decorated with one or more colors, decorative prints. Alternatively, no colors or decorative prints may be provided. A spunlaced fabric according to embodiments of the present invention may have a transparent configuration such that a printed backing layer can provide an aesthetically pleasing appearance through the spunlaced fabric without requiring printing directly on the spunlaced fabric.

Referring now to FIGS. 6-7, a method of forming a loop component for use in a hook and loop fastening system, according to other embodiments of the present invention, includes forming a spunlaced fabric having a plurality of loop structures from a plurality of non-interbonded fibers (i.e., fibers not bonded to other fibers) in a fibrous web of material (Block 2000), stretching the spunlaced fabric in a cross web (widthwise) direction (Block 2100), optionally bonding one or more portions of the spunlaced fabric (Block 2200), optionally embossing the spunlaced fabric with a decorative pattern or other decorative indicia (Block 2300), and optionally bonding the spunlaced fabric to a backing layer (Block 2400).

The term “cross web direction” refers to the width direction of an elongated fabric. The cross web direction is orthogonal to the machine direction of an elongated fabric during manufacturing. According to embodiments of the present invention, spunlaced fabric may be stretched in the cross web direction (Block 2100) between about 5% and about 125% of the original width of the spunlaced fabric. Stretching in the cross web direction may be performed in a variety of ways including, but not limited to, stretching via ring rolls or interdigitating rolls, bow rolls, tentering, etc.

Interdigitating rolls are a particularly preferred way of stretching. As known to those skilled in the art, interdigitating rolls include a set of thin knife like discs on two central shafts. The rolls extend into each other with individual rings meshing together. An example of interdigitating rolls is described in U.S. Pat. No. 5,628,097 which is incorporated herein by reference in its entirety. When a spunlaced fabric according to embodiments of the present invention is passed through the interdigitating rolls, the spunlaced fabric is incrementally stretched between each set of knife edges along the width. This process imparts very uniform expansion of the sheet and may be done at ambient conditions or while heating.

Stretching spunlaced fabric in the cross web direction according to embodiments of the present invention tends to produce a fabric with greater void area for better hook engagement. In addition, stretching spunlaced fabric in the cross web direction in accordance with the present invention can produce a fabric that can be lower in basis weight than can be produced on conventional spunlacing equipment.

Bonding a spunlaced fabric (Block 2200) may include autogenously bonding in multiple spaced apart patterns (Block 2210) or autogenously bonding in a continuous bond pattern (Block 2220) (FIG. 7). Bonding may be performed in a variety of ways known to those skilled in the art including, but not limited to, thermal bonding and ultrasonic bonding. Bonding may be performed directly to a spunlaced fabric itself or a spunlaced fabric may be bonded to a decorative film or fabric. According to embodiments of the present invention, between about 2.5% and about 25% of the surface area of a spunlaced fabric is bonded.

The basis weight of a stretched spunlaced fabric according to embodiments of the present invention may be between about 15 and about 75 grams per meter (ASTM D-5261). The average peel strength of a stretched spunlaced fabric according to embodiments of the present invention may be between about 50 grams and about 750 grams force. The average maximum load (highest peak) peel strength of a stretched spunlaced fabric according to embodiments of the present invention may be between about 200 and 7,000 grams force. The average maximum load shear strength of a stretched spunlaced fabric according to embodiments of the present invention may be between about 700 and 10,000 grams force (ASTM D5170-98 and ASTM D5169-91). The air permeability of a stretched spunlaced fabric according to embodiments of the present invention may be between about 250 and 800 cubic feet per minute (ASTM D 737). The caliper or thickness of a stretched spunlaced fabric according to embodiments of the present invention may be between about 0.010 and 0.045 inches (ASTM D5199).

### EXAMPLE 1

A web consisting of a 50/50 blend of 6.7 dtex/2.2 dtex polypropylene fibers is hydroentangled on a spunlacing line to produce a spunlaced nonwoven fabric. The 6.7 dtex fibers are 60 mm in length and the 2.2 dtex fibers are 40 mm in length. The spunlaced fabric is produced at 48 grams per square meter weight (by ASTM D5261), using a medium spunlacing energy and a 3 to 1 machine direction to cross direction fiber ratio orientation. The spunlaced fabric has a minimum grab tensile of 16 pounds in the machine direction and 10 pounds in the cross direction as tested by ASTM D-4632. The average load peel strength, when tested with Binder 25445 hooks, is a minimum average of 125 grams force using test method ASTM D 5170-98.

The spunlaced web is subsequently thermally bonded between a pattern roll positioned above a smooth anvil roll. The pattern consists of discontinuous alternating double hash marks in the diagonal direction. The spunlaced web is nipped between these rolls at a pressure of approximately 600 pounds per linear inch (pli) of roll face and a web temperature of approximately 275° F. The thermal bonding machine speed is set at 500 feet per minute. The web is wound up on the exit end into a roll with the pattern side wound in. The pattern is the side of the web that is used as a landing zone. The non-pattern side will be glued to the diaper back sheet. The width of web is slit to each customer's specification, usually 6.5″ to 8″ width.

The basis weight of the landing zone material is 42 grams per meter (ASTM D-5261). The grab tensile is 14 pounds in the machine direction and 8 pound in the cross direction as tested by ASTM D-4632. The elongation is 190% in the machine direction and 220% in the cross direction as tested by ASTM D-4632. The average maximum load (highest peak), peel strength is 350 grams force using method ASTM D5170-98. The average maximum load shear strength is 3,000 grams force using method ASTM D5169-91. Both peel and shear tests are performed using Binder 25445 polypropylene hooks.

### EXAMPLE 2

The same processes as above, but after the thermal bonding process the spunlaced loop material is stretched in the cross direction. The amount of cross directional stretch is about 25%. The reason for stretching the web is to increase fabric utilization (more slits), reduce weight, and to “open the web” more. While ring roll or interdigitating roll stretching is preferred, the spunlaced loop structure may be stretched using bow rolls, tentering, or other stretching means known to the art. The stretched web is less dense with more void area and generally the pattern or loop side engages more easily with commercially available hook components, such as the Binder 25445 polypropylene hooks.

### EXAMPLE 3

A web consisting of a 50/50 blend of 6.7 dtex/2.2 dtex polypropylene fibers is hydroentangled on a spunlacing line to produce a spunlaced nonwoven fabric. The 6.7 dtex fibers are 60 mm in length and the 2.2 dtex fibers are 40 mm in length. The spunlaced fabric is produced at 48 grams per square meter weight using a medium spunlacing energy and a 3 to 1 ratio machine direction to cross direction fiber orientation. The spunlaced fabric has a minimum grab tensile of 16 pounds in the machine direction and a minimum of 10 pounds in the cross direction as tested by ASTM D-4632. The average load peel strength, when tested with Binder 25445 hooks, is a minimum average of 125 grams force using test method ASTM D 5170-98.

The spunlaced loop structure is subsequently stretched in the cross direction 40% over the original width of the web. The stretching of the web is accomplished using a ring roll apparatus. The stretched web is then thermally bonded to a decorative film backing material in order to improve the aesthetics. Thermal bonding is accomplished using a pattern roll positioned above a smooth anvil roll. The pattern consists of continuous alternating double hash marks in the diagonal direction. The spunlaced web and decorative film are nipped between these rolls at a pressure of approximately 600 pli and a web temperature of approximately 275° F. The thermal bonding machine speed is set at 500 feet per minute. The thermally bonded web is wound up into a roll and slit to each customer specifications.

The landing zone material has a basis weight of 47 grams per meter as tested by ASTM D-5261). The grab tensile is 12 pounds in the machine direction and 7 pounds in the cross direction as tested by ASTM D-4362. The elongation is 118% in the machine direction and 45% in the cross direction (ASTM D-4362). The caliper or thickness of the material is 0.023 inches (ASTM D-5199). The average maximum load (highest peak), peel strength is 300 grams force using ASTM D 5170-98. The average maximum load shear strength is 2,500 grams force using ASTM D 5169-91. Both the peel and shear tests were performed using Binder 25445 polypropylene hooks.

EXAMPLE #4
ASTM PEEL AND SHEAR TESTING
Instrument: Instron 4442 using 100# load cell (500 Newtons). Method 93.
Test Method: ASTM test methods for peel and shear (D 5170-98 and D 5169-91). Binder 25445 PP hooks used for testing.

| | | | ASTM Peel | | | | ASTM Shear | | | | | |
|---|---|---|---|---|---|---|---|---|---|---|---|---|
| | | | | Max | | Std. | | Max | | Std. | | |
| | Sample | Test | | Load | | Dev. | | Load | | Dev. | | |
| Construction | ID | Method | Hooks | Of | n= | Of | Range | of | n= | Of | Range | Comments |
| Spunlace loop | Sample | ASTM | Binder | 555 | 20 | 150 | 329 | 4,528 | 20 | 1,041 | 2,355 | Very high fuzzing and |
| alone (no | 2249-1 | | | | | | to | | | | to | pull out |
| bonding) | | | | | | | 828 | | | | 5,888 | |
| Spunlace loop | Diamond | ASTM | Binder | 518 | 20 | 132 | 238 | 7,887 | 20 | 922 | 5,434 | Some fuzzing and few |
| thermally | Dispo | | | | | | to | | | | to | pull outs |
| bonded (no | 400948 | | | | | | 685 | | | | 9,262 | |
| backing) | | | | | | | | | | | | |
| Spunlace loop | Sample | ASTM | Binder | 613 | 20 | 193 | 389 | 3,191 | 20 | 818 | 1,736 | Very high fuzzing and |
| glue bonded to | 22462-1 | | | | | | to | | | | to | pull out |
| a film backing | | | | | | | 1,079 | | | | 4,663 | |
| Spunlace | Diamond | ASTM | Binder | 576 | 20 | 113 | 406 | 6,388 | 20 | 1,581 | 3,713 | Some fuzzing and few |
| thermally | Dispo | | | | | | to | | | | to | pull outs |
| bonded to film | 400825 | | | | | | 758 | | | | 9,181 | |
| backing | | | | | | | | | | | | |

Note:
1 - Tape backing used for all peel samples that are unbacked.
2 - Tape backing used for all shear samples.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A method of forming a loop component for use in a hook and loop fastening system, comprising:
entangling a plurality of non-interbonded fibers in a fibrous web of material to form a spunlaced fabric having a plurality of loop structures that are configured to engage hooks from a hook component; and
bonding between about two percent and about twenty five percent (2%-25%) of the spunlaced fabric to reduce fiber fuzzing and pull out caused by hooks engaging with and disengaging from a loop component.

2. The method of claim 1, wherein entangling a plurality of non-interbonded fibers comprises directing one or more jets of high-pressure water at the fibrous web of material.

3. The method of claim 1, wherein bonding comprises bonding the spunlaced fabric in a continuous bond pattern.

4. The method of claim 1, wherein bonding comprises bonding the spunlaced fabric in multiple, spaced apart bond patterns.

5. The method of claim 1, wherein bonding the spunlaced fabric comprises thermally, adhesively, or ultrasonically bonding the spunlaced fabric.

6. The method of claim 1, wherein bonding the spunlaced fabric comprises autogenously bonding the spunlaced fabric.

7. The method of claim 1, further comprising bonding the spunlaced fabric to a backing layer.

8. The method of claim 7, wherein bonding the spunlaced fabric to a backing layer comprises thermally, adhesively, or ultrasonically bonding the spunlaced fabric to the backing layer.

9. The method of claim 7, wherein bonding comprises autogenously bonding the spunlaced fabric to the backing layer in a pattern.

10. The method of claim 9, wherein the bond pattern comprises a continuous bond pattern.

11. The method of claim 9, wherein the bond pattern comprises a repeat unit of between about 0.2 cm and 12 cm.

12. The method of claim 10, wherein the bond pattern comprises elements having dimensions between about 0.02 mm and 4 mm.

13. The method of claim 9, wherein the spunlaced fabric is bonded to between about two percent and about twenty-five percent (2%-25%) of a surface area of the backing layer.

14. The method of claim 7, further comprising providing the backing layer with decorative indicia and/or coloring.

15. The method of claim 1, further comprising embossing the spunlaced fabric with a decorative pattern.

16. A method of forming a loop component for use in a hook and loop fastening system, comprising:
entangling a plurality of non-interbonded fibers in a fibrous web of material to form a spunlaced fabric having a plurality of loop structures that are configured to engage hooks from a hook component; and
stretching the spunlaced fabric in a cross web direction between about five percent and one-hundred twenty five percent (5%-125%) of the unstretched width of the spunlaced fabric.

17. The method of claim 16, further comprising bonding between about two percent and about twenty five percent (2%-25%) of the spunlaced fabric to reduce fiber fuzzing and pull out caused by hooks engaging with and disengaging from a loop component.

18. The method of claim 16, wherein entangling a plurality of non-interbonded fibers comprises directing one or more jets of high-pressure water at the fibrous web of material.

19. The method of claim 17, wherein bonding comprises bonding the spunlaced fabric in a continuous bond pattern.

20. The method of claim 17, wherein bonding comprises bonding the spunlaced fabric in multiple, spaced apart bond patterns.

21. The method of claim 17, wherein bonding the spunlaced fabric comprises thermally, adhesively, or ultrasonically bonding the spunlaced fabric.

22. The method of claim 17, wherein bonding the spunlaced fabric comprises autogenously bonding the spunlaced fabric.

23. The method of claim 16, further comprising bonding the spunlaced fabric to a backing layer.

24. The method of claim 23, wherein bonding the spunlaced fabric to a backing layer comprises thermally, adhesively, or ultrasonically bonding the spunlaced fabric to the backing layer.

25. The method of claim 23, wherein bonding comprises autogenously bonding the spunlaced fabric to the backing layer in a pattern.

26. The method of claim 25, wherein the bond pattern comprises a continuous bond pattern.

27. The method of claim 25, wherein the bond pattern comprises a repeat unit of between about 0.2 cm and 12 cm.

28. The method of claim 26, wherein the bond pattern comprises elements having dimensions between about 0.02 mm and 4 mm.

29. The method of claim 23, wherein the spunlaced fabric is bonded to between about two percent and about twenty-five percent (2%-25%) of a surface area of the backing layer.

30. The method of claim 23, further comprising providing the backing layer with decorative indicia and/or coloring.

31. The method of claim 16, further comprising embossing the spunlaced fabric with a decorative pattern.

32. A loop component for use in a hook and loop fastening system, comprising a spunlaced fabric having a plurality of loop structures formed by entangling a plurality of non-interbonded fibers in a fibrous web of material, wherein between about two percent and about twenty-five percent (2%-25%) of a surface area of the spunlaced fabric is bonded to reduce fiber fuzzing and pull out caused by hooks engaging with and disengaging from the loop component.

33. The loop component of claim 32, wherein the spunlaced fabric is stretched in a cross web direction between about five percent and about one hundred twenty-five percent (5%-125%) of an unstretched width of the spunlaced fabric.

34. The loop component of claim 32, wherein the loop structures of the spunlaced fabric are configured to engage hooks from a hook component having a hook density between about 30 and 400 hooks per square centimeter.

35. The loop component of claim 32, wherein the loop structures of the spunlaced fabric are configured to engage hooks from a hook component having individual hook lengths of 0.8 cm or less.

36. The loop component of claim 32, wherein the loop structures of the spunlaced fabric have an average peel strength of between about 50 grams and 750 grams when tested using ASTM D5170-98 test method.

37. The loop component of claim 32, wherein the loop structures of the spunlaced fabric have an average maximum load peel strength of between about 700 grams and 10,000 grams when tested using ASTM D5170-98 test method.

38. The loop component of claim 32, wherein the loop structures of the spunlaced fabric have an average peak shear strength of between about 200 and 7,000 grams when tested using ASTM D5169-91 test method.

39. The loop component of claim 32, wherein the loop structures of the spunlaced fabric maintain a maximum average peel strength after 20 test cycles between about 50 and 550 grams when tested using ASTM D5170-98 test method.

40. The loop component of claim 32, wherein the fibers of the spunlaced fabric have a denier of between about 0.5 and 19.

41. The loop component of claim 32, wherein the fibers of the spunlaced fabric have a density of between about 0.1 and 1.2 grams per cubic centimeter.

42. The loop component of claim 32, wherein the spunlaced fabric has a thickness of between about 10 and 95 mils.

43. The loop component of claim 32, wherein the non-interbonded fibers of the fibrous web comprise fibers selected from the group consisting of polypropylene, polyethylene, polyethylene terephthalate, polyester, acetate, nylon, viscose and acrylic, or blends or bicomponents thereof.

44. The loop component of claim 32, wherein the spunlaced fabric is embossed with a decorative pattern.

45. The loop component of claim 32, further comprising a backing layer bonded to the spunlaced fabric.

46. The loop component of claim 45, wherein the backing layer comprises material selected from the group consisting of polypropylene, polyethylene, polyester, acetate, nylon, urethane, or blends thereof, polymer film, nonwoven fabric, woven fabric, and knit scrim.

47. The loop component of claim 45, wherein the backing layer comprises polyolefin film having a density less than about 0.91 grams per cubic centimeter.

48. The loop component of claim 45, wherein the backing layer is bonded to the spunlaced fabric either thermally, adhesively, autogenously, or ultrasonically.

49. The loop component of claim 45, wherein the backing layer comprises material impervious to water.

50. The loop component of claim 45, wherein the backing layer has a thickness between about 0.4 and 40 mils.

51. The loop component of claim 45, wherein the backing layer has a density of between about 0.65 and 1.4 grams per cubic centimeter.

52. The loop component of claim 45, wherein the spunlaced fabric and backing layer has a thickness between about 8 mils and 400 mils.

53. The loop component of claim 45, wherein the spunlaced fabric and backing layer has a basis weight greater than or equal to 19 grams per square meter.

54. The loop component of claim 45, wherein the spunlaced fabric and backing layer has a Frazier air permeability of less than about 25 cubic feet per minute.

55. The loop component of claim 45, wherein the spunlaced fabric and backing layer has a machine direction (MD) grab tensile strength of between about 10 pounds and 40 pounds.

56. A hook and loop fastening system, comprising:
a hook component having a hook density between about 30 and 400 hooks per square centimeter; and
a loop component, comprising a spunlaced fabric having a plurality of loop structures formed by entangling a plurality of non-interbonded fibers in a fibrous web of material, wherein the loop structures of the spunlaced fabric are configured to engage hooks from the hook component, and wherein between about two percent and about twenty-five percent (2%-25%) of a surface area of the spunlaced fabric is bonded to reduce fiber fuzzing and pull out caused by hooks from the hook component engaging with and disengaging from the loop component.

57. The hook and loop fastening system of claim 56, wherein the loop component spunlaced fabric is stretched in a cross web direction between about five percent and about one hundred twenty-five percent (5%-125%) of an unstretched width of the spunlaced fabric.

58. The hook and loop fastening system of claim 56, wherein the loop structures of the spunlaced fabric are configured to engage hooks having individual hook lengths of 0.8 cm or less.

59. The hook and loop fastening system of claim 56, wherein the loop structures of the spunlaced fabric have an average peel strength of between about 50 grams and 550 grams when tested using ASTM D5170-98 test method.
